(19) United States
(12) Patent Application Publication
(10) Pub. No.: US 2003/0219553 A1
(43) Pub. Date: Nov. 27, 2003

(54) Recording element for ink jet printing

(76) Inventor: Marc Graindourze, Overpelt (BE)

Correspondence Address: Joseph T. Guy Ph. D., Nexsen Pruet Jacobs & Pollard LLP, 201 W. McBee Avenue, Greenville, SC, 29603, US

(21) Appl. No.: 10/403,067

(22) Filed: Mar. 31, 2003

Related U.S. Application Data
(60) Provisional application No. 60/385,363, filed on Jun. 3, 2002.

(30) Foreign Application Priority Data
May 24, 2002 (EP) 02100557.4

(51) Int. Cl. B32B 3/00

(52) U.S. Cl. 428/32.1

(57) ABSTRACT

An improved ink jet recording material is disclosed comprising a resin coated paper support and an ink receiving layer, characterized in that between said support and said ink receiving layer there is an adhesion promoting layer present comprising a binder and a cationic inorganic pigment.

The application claims the benefit of U.S. Provisional Application No. 60/385,363 filed Jun. 3, 2002.

### FIELD OF THE INVENTION

The present invention relates to an improved recording element for ink jet printing.

### BACKGROUND OF THE INVENTION

In the majority of applications printing proceeds by pressure contact of an ink-loaden printing form with an ink-receiving material which is usually plain paper. The most frequently used impact printing technique is known as lithographic printing based on the selective acceptance of oleophilic ink on a suitable receptor. In recent times however so-called non-impact printing systems have replaced classical pressure-contact printing to some extent for specific applications. A survey is given e.g. in the book “Principles of Non Impact Printing” by Jerome L. Johnson (1986), Palatino Press, Irvine, Calif. 92715, USA.

Among non-impact printing techniques ink jet printing has become a popular technique because of its simplicity, convenience and low cost. Especially in those instances where a limited edition of the printed matter is needed ink jet printing has become a technology of choice. A recent survey on progress and trends in ink jet printing technology is given by Hue P. Le in Journal of Imaging Science and Technology Vol. 42 (1), January/February 1998.

In ink jet printing tiny drops of ink fluid are projected directly onto an ink receptor surface without physical contact between the printing device and the receptor. The printing device stores the printing data electronically and controls a mechanism for ejecting the drops image-wise. Printing is accomplished by moving the print head across the paper or vice versa. Early patents on ink jet printers include U.S. Pat. No. 3,739,393, U.S. Pat. No. 3,805,273 and U.S. Pat. No. 3,891,121.

The jetting of the ink droplets can be performed in several different ways. In a first type of process a continuous droplet stream is created by applying a pressure wave pattern. This process is known as continuous ink jet printing. In a first embodiment the droplet stream is divided into droplets that are electrostatically charged, deflected and recollected, and into droplets that remain uncharged, continue their way undeflected, and form the image.

Alternatively, the charged deflected stream forms the image and the uncharged undeflected jet is recollected. In this variant of continuous ink jet printing several jets are deflected to a different degree and thus record the image (multideflection system).

According to a second process the ink droplets can be created “on demand” (“DOD” or “drop on demand” method) whereby the printing device ejects the droplets only when they are used in imaging on a receiver thereby avoiding the complexity of drop charging, deflection hardware, and ink recollection. In drop-on-demand the ink droplet can be formed by means of a pressure wave created by a mechanical motion of a piezoelectric transducer (so-called “piezo method”), or by means of discrete thermal pushes (so-called “bubble jet” method, or “thermal jet” method).

Ink compositions for ink jet typically include following ingredients: dyes or pigments, water and/or organic solvents, humectants such as glycols, detergents, thickeners, polymeric binders, preservatives, etc. It will be readily understood that the optimal composition of such an ink is dependent on the ink jetting method used and on the nature of the substrate to be printed. The ink compositions can be roughly divided in:

water based; the drying mechanism involves absorption, penetration and evaporation;

oil based; the drying involves absorption and penetration;

solvent based; the drying mechanism involves primarely evaporation;

hot melt or phase change: the ink vehicle is liquid at the ejection temperature but solid at room temperature; drying is replaced by solidification;

UV-curable; drying is replaced by polymerization.

It is known that the ink-receiving layers in ink-jet recording elements must meet different stringent requirements:

The ink-receiving layer should have a high ink absorbing capacity, so that the dots will not flow out and will not be expanded more than is necessary to obtain a high optical density.

The ink-receiving layer should have a high ink absorbing speed (short ink drying time) so that the ink droplets will not feather if smeared immediately after applying.

The ink dots that are applied to the ink-receiving layer should be substantially round in shape and smooth at their peripheries. The dot diameter must be constant and accurately controlled.

The receiving layer must be readily wetted so that there is no “puddling”, i.e. coalescence of adjacent ink dots, and an earlier absorbed ink drop should not show any “bleeding”, i.e. overlap with neighbouring or later placed dots.

Transparent ink-jet recording elements must have a low haze-value and be excellent in transmittance properties.

After being printed the image must have a good resistance regarding water-fastness, light-fastness, and good endurance under severe conditions of temperature and humidity.

The ink jet recording element may not show any curl or sticky behaviour if stacked before or after being printed.

The ink jet recording element must be able to move smoothly through different types of printers.

All these properties are often in a relation of trade-off. It is difficult to satisfy them all at the same time.

Especially when the finished ink jet image is meant to have a “near photographic quality” outlook it is commonly known to use resin coated paper (RC-paper) as support. This support is usually polyethylene or polypropylene coated high quality paper, as it is also widely used in photographic industry. A problem when using such supports for ink receiving layers is the criticallity of the so-called “adhesion dry” property. This means that on further handling of the finished ink jet image the ink receiver layer tends to get loose from the RC-paper support. When this phenomenon occurs in several areas the finished image gets a crumpled outlook and becomes unsuitable. In photographic industry where RC-paper is widely used as support for photographic print paper the problem of the bad adhesion between the hydrophobic olefinic resin coating and the hydrophilic light-sensitive layer(s) is solved by providing the RC-support support with at least one and preferably two so-called subbing layers. However, it was found experimentally that this measure did not solve completely the problem of insufficient “adhesion dry” when typical ink receiver compositions are coated on a such a RC-paper support.

### SUMMARY OF THE INVENTION

The present invention seeks to remedy the problem of insufficient adhesion in dry state when RC-coated paper is used as support for a typical ink receiver layer.

The present invention further seeks to shorten the drying time after ink jet printing.

The above-mentioned desired advantageous effects are realised by providing an ink jet recording material comprising a resin coated paper support and an ink receiving layer, characterized in that between said support and said ink receiving layer there is an adhesion promoting layer present comprising a binder and a cationic inorganic pigment.

In a preferred embodiment this cationic inorganic pigment is chosen from the group consisting of aluminum oxides, aluminum hydroxides, alumina hydrates, aluminum silicates, and cationically modified silicas.

Further advantages and embodiments of the present invention will become apparent from the following description.

### DETAILED DESCRIPTION OF THE INVENTION

We will now firstly explain in detail the composition of the different layers of the ink jet recording material according to the present invention.

The Resin Coated Paper Support

The paper used for RC-paper has usually photograde quality which means that it has a very uniform outlook. The thickness corresponds to about 100-200 g/m². The resin can be chosen from several olefinic polymers, e.g. polyethylene (PE) or polypropylene. Most preferred is polyethylene which can be high density or low density polyethylene or mixtures of both. The thickness may vary between 10 and 30 μm. After extrusion of the polyethylene a coronation treatment may be performed. The resin coverage may be symmetrical (the same on both sides), or asymetrical, e.g. more on the back side for anti-curl purposes. The resin layers may contain whitening agents such as titanium dioxide. When a subbing layer is present it is usually based on a gelatinous composition.

The Adhesion Promoting Layer

It is essential to the present invention that the adhesion promoting layer comprises a cationic inorganic pigment and a binder.

The term “cationic inorganic pigment” as used in the present invention means a substance composed of fine particles having a positive charge on their surfaces. Specific examples thereof include fine particles composed of oxides of metals such as magnesium, calcium, aluminum, zirconium, zinc, chromium, iron, copper, tin, lead and manganese. Those having a negative charge on their surfaces like silica may also be used if they are surface-treated to change the negative charge on the surface to a positive charge.

The cationic inorganic pigment is preferably chosen from the group consisting of aluminum oxides, aluminum hydroxides, alumina hydrates, aluminum silicates, and cationically modified silicas.

A preferred type of alumina hydrate is crystalline boehmite, or γ-AlO(OH). Useful types of boehmite include, in powder form, DISPERAL, DISPERAL HP14 and DISPERAL 40 from Sasol, MARTOXIN VPP2000-2 and GL-3 from Martinswerk GmbH.; liquid boehmite alumina systems, e.g. DISPAL 23N4-20, DISPAL 14N-25, DISPERAL AL25 from Sasol. Patents on alumina hydrate include EP 500021, EP 634286, U.S. Pat. No. 5,624,428, EP 742108, U.S. Pat. No. 6,238,047, EP 622244, EP 810101, etc. Other useful cationic inorganic pigments include aluminum oxide (alumina), e.g. α-Al₂O₃ types, such as NORTON E700, available from Saint-Gobain Ceramics & Plastics, Inc, γ-Al₂O₃ types, such as ALUMINUM OXID C from Degussa; other aluminum oxide grades, such as BAIKALOX CR15 and CR30 from Baikowski Chemie; DURALOX grades and MEDIALOX grades from Baikowski Chemie, BAIKALOX CR80, CR140, CR125, B105CR from Baikowski Chemie; CAB-O-SPERSE PG003 trademark from Cabot, CATALOX GRADES and CATAPAL GRADES from from Sasol, such as PLURALOX HP14/150; colloidal Al₂O₃ types, such as ALUMINASOL 100; ALUMINASOL 200, ALUMINASOL 220, ALUMINASOL 300, and ALUMINASOL 520 trademarks from Nissan Chemical Industries or NALCO 8676 trademark from ONDEO Nalco.

Other useful cationic inorganic pigments include aluminum trihydroxides such as Bayerite, or α-Al(OH)₃, such as PLURAL BT, available from Sasol, and Gibbsite, or γ-Al(OH)₃, such as MARTINAL grades from Martinswerk GmbH, MARTIFIN grades, such as MARTIFIN OL104, MARTIFIN OL 107 and MARTIFIN OL111 from Martinswerk GmbH MICRAL grades, such as MICRAL 1440, MICRAL 1500; MICRAL 632; MICRAL 855; MICRAL 916; MICRAL 932; MICRAL 932CM; MICRAL 9400 from J M Huber company; HIGILITE grades, e.g. HIGILITE H42 or HIGILITE H43M from Showa Denka K.K.

Another useful type of cationic pigment is zirconium oxide such as NALCO OOSS008 trademark of ONDEO Nalco, acetate stabilized ZrO₂, ZR20/20, ZR50/20, ZR100/20 and ZRYS4 trademarks from Nyacol Nano Technologies.

Useful mixed oxides are SIRAL grades from Sasol, colloidal metaloxides from Nalco such as Nalco 1056, Nalco TX10496, Nalco TX11678.

Another preferred type of cationic inorganic pigment is cationically modified silica. Silica as pigment in ink receiving elements is disclosed in numerous old and recent patents, e.g. U.S. Pat. No. 4,892,591, U.S. Pat. No. 4,902,568, EP 373573, EP 423829, EP 487350, EP 493100, EP 514633, etc. The silica, before cationic modification, can be chosen from different types, such as crystalline silica, amorphous silica, precipitated silica, fumed silica, silica gel, spherical and non-spherical silica. The silica may contain minor amounts of metal oxides from the group Al, Zr, Ti. Useful types include AEROSIL OX50 (BET surface area 50±15 m²/g, average primary particle size 40 nm, SiO₂ content>99.8%, Al₂O₃ content<0.08%), AEROSIL MOX170 (BET surface area 170 g/m², average primary particle size 15 nm, SiO₂ content>98.3%, Al₂O₃ content 0.3-1.3%), AEROSIL MOX80 (BET surface area 80±20 g/m², average primary particle size 30 nm, SiO₂ content>98.3%, Al₂O₃ content 0.3-1.3%), or other hydrophilic AEROSIL grades available from Degussa-Hüls AG, which may give aqueous dispersions with a small average particle size (<500 nm).

Cationically modified silica can be prepared by following methods, without meaning to be limitative:

(1) subjecting silica to a surface treatment with an inorganic cationic compound such as particular metal oxides and oxyhydroxides, e.g. aluminum oxides, and alumina hydrates such as boehmite and pseudo-boehmite; an example of such preparation route is described in the following references:

Cationic silica dispersion for recording material. Field, Rex J.; Darsillo, Michael S.; Fluck, David J.; Laufhutte, Rudiger. (Cabot Corporation, USA). WO 00/20221

Ink jet recording element containing colloidal silica. Chu, Lixin; Romano, Charles Eugene, Jr.; Chen, Chen C. Eastman Kodak Co.) EP 983867

Recording medium excellent in ink absorptivity and process for its production, and process for producing silica-alumina composite sol. Nakahara, Katsumasa; Inokuma, Hisao; Hirano, Hachirou; Matsubara, Toshiya; Wakabayashi, Masako; Kon, Yoshinori. (Asahi Glass Company Ltd., Japan). EP 1112962 A1

Ink-receptive coating for ink-jet recording material. Chapman, David Monroe. (W. R. Grace & Co.-Conn., USA). WO 00/02736

A useful cationic inorganic compound to modify silica is pseudo-boehmite. Pseudo-boehmite is also called boehmite gel and is fine particulate alumina hydrate having a needle form. The composition thereof is generally represented by Al₂O₃.1.5-2 H₂O and differs from that of crystalline boehmite.

(2) by subjecting silica to a surface treatment with an organic compound having both an amino group or quaternary ammonium group thereof or a quaternary phosphonium group, and a functional group having reactivity to a silanol group on the surface of silica, such as aminoalkoxysilane or aminoalkyl glycidyl ether or isopropanol amine, examples of such preparation routes are described in:

Ink-jet printing ink-accepting compositions comprising cation-modified silica, vinyl polymers and cationic polymers for printing fabrics using ink-jet printers with high color depth and printing fabrics coated or impregnated with the compositions. Yasuda, Masahiro; Okudo, Toshifumi; Hirota, Yasuhide. (Kyoeisha Chemical Co., Ltd., Japan). JP-A 2000265380

Ink-jet-printable image-transfer medium, process for transferring image, and cloth imaged by this process. Sato, Yuko; Higuma, Masahiko; Shino, Yoshiyuki. (Canon Kabushiki Kaisha, Japan). EP 933225 A1

Adsorption of cationic surfactants on highly dispersed silica. Mikhailova, I. V.; Gerashchenko, I. I. Institute of Surface Chemistry, National Academy of Sciences of Ukraine, Kiev, Ukraine. Colloid J. (2001), 63(4), 437-440.

Functionalization of silica particles towards cationic polyelectrolytes using vinylformamide and 1,3-divinylimidazolidin-2-one as monomers. Meyer, Torsten; Rehak, Petra; Jager, Christian; Voigt, Ina; Simon, Frank; Spange, Stefan. Polymer Chemistry, Institute for Chemistry, Chemnitz University of Technology, Chemnitz, Germany. Macromol. Symp. (2001), 163 (Tailormade Polymers), 87-96.

Image receiving element and method of manufacturing the element. Yarmey, Susan K.; Steiner, Michael L. (Imation Corp., USA). WO 01/05599

Coated paper with good printability for ink-jet printing. Hirose, Mifune; Sakaki, Mamoru; Katayama, Masato; Higuma, Masahiko; Moriya, Kenichi; Nishioka, Yuko. (Canon K. K., Japan). EP 732219 A2

Manufacture of porous, laminar, inorganic products. Yokoyama, Masaru; Hirao, Shozo; Kishimoto, Takashi; Takahama, Koichi. (Matsushita Electric Works, Ltd., Japan). JP-A 62176969

(3) by polymerisation of a cationic or amino functional monomer in the presence of a silica, e.g. as descibed in:

Ink-jet printing sheet containing cationic silica. Ito, Hiroshi; Sawamoto, Hidetada; Hasegawa, Makoto. (Oji Paper Co., Ltd., Japan). JP-A 2001293948

Grafting of polymers with controlled molecular weight onto carbon black and ultrafine silica surface. Tsubokawa, Norio; Yoshikawa, Sachio. Department of Material Science and Technology, Faculty of Engineering, Niigata University, Niigata, Japan. Recent Res. Dev. Polym. Sci. (1998), 2(Pt. 2), 211-228.

Cationic polymer synthesis at inorganic surfaces. Spange, S. Inst. Org. Chem. Macromol. Chem., Jena Univ., Jena, Germany. Vysokomol. Soedin., Ser. A Ser. B (1993), 35(11), 1873-7.

In principle, mixtures of more than one cationic inorganic pigment can be used in the adhesion promoting layer.

The binder can be chosen from a list of compounds well-known in the art including hydroxyethyl cellulose; hydroxypropyl cellulose; hydroxyethylmethyl cellulose; hydroxypropyl methyl cellulose; hydroxybutylmethyl cellulose; methyl cellulose; sodium carboxymethyl cellulose; sodium carboxymethylhydroxethyl cellulose; water soluble ethylhydroxyethyl cellulose; cellulose sulfate; polyvinyl alcohol; vinylalcohol copolymers; polyvinyl acetate; polyvinyl acetal; polyvinyl pyrrolidone; polyacrylamide; acrylamide/acrylic acid copolymer; polystyrene, styrene copolymers; acrylic or methacrylic polymers; styrene/acrylic copolymers; ethylene-vinylacetate copolymer; vinylmethyl ether/maleic acid copolymer; poly(2-acrylamido-2-methyl propane sulfonic acid); poly(diethylene triamine-co-adipic acid); polyvinyl pyridine; polyvinyl imidazole; polyethylene imine epichlorohydrin modified; polyethylene imine ethoxylated; polyethylene oxide; polyurethane; melamine resins; gelatin; carrageenan; dextran; gum arabic; casein; pectin; albumin; starch; collagen derivatives; collodion and agar-agar.

A preferred binder for the practice of the present invention is a polyvinylalcohol (PVA), a vinylalcohol copolymer or modified polyvinyl alcohol. Most preferably, the polyvinyl alcohol is a cationic type polyvinyl alcohol, such as the cationic polyvinyl alcohol grades from Kuraray, such as POVAL C506, POVAL C118, and from Nippon Goshei.

Mixtures of two or more binders can be used.

The ratio cationic pigment/binder in the adhesion promoting layer is preferably between 1:4 and 10:1.

The coverage of the adhesion promoting layer is preferably comprised between 1 and 8 g/m².

The Ink Receiving Layer

Two different types of ink receiving layer may be considered for the practice of the present invention.

In a first embodiment, which is known as “the polymeric blend” type, the ink receiver layer comprises substantially only one or more film-forming polymers. The ink-absorptivity is based on locally swelling of the layer after being hit by the ink droplets.

The polymer(s) can readily be chosen from the polymeric binders as enumerated above for the adhesion promoting layer. Preferably, the polymers are selected from gelatin, polyvinyl alcohol and derivatives, polyvinyl pyrrolidone and derivatives, cellulosic ethers and derivatives, polyurethanes, and polyethylene oxides.

In a second embodiment, which is known as the porous or microporous type the ink receiver comprises a pigment and a binder in a rather large ratio of amount pigment versus amount binder. The ink absorbing capacity is based on microcapillary forces.

The pigment may be chosen from the cationic inorganic pigments as enumerated for the adhesion promoting layer, but also neutral or anionic pigment types may be used. Useful pigments include e.g. silica, talc, clay, hydrotalcite, kaolin, diatomaceous earth, calcium carbonate, magnesium carbonate, basic magnesium carbonate, aluminosilicate, aluminum trihydroxide, aluminum oxide (alumina), titanium oxide, zinc oxide, barium sulfate, calcium sulfate, zinc sulfide, satin white, boehmite (alumina hydrate), zirconium oxide or mixed oxides. Preferably, the pigment is selected from aluminum oxides, aluminum hydroxides, alumina hydrates, aluminum silicates, and cationically modified silicas.

In an alternative embodiment the pigment may be chosen from organic particles such as polystyrene, polymethyl methacrylate, silicones, melamine-formaldehyde condensation polymers, urea-formaldehyde condensation polymers, polyesters and polyamides. Mixtures of inorganic and organic pigments can be used. However, most preferably the pigment is an inorganic pigment.

The binder may again be chosen from the list given above. The pigment must be present in a sufficient coverage in order to render the ink receiving layer sufficiently porous. The lower limit of the ratio by weight of the binder to the total pigment in the ink receiving layer is preferably about 1:50, most preferably 1:20, while the upper limit thereof is about 2:1, most preferably 1:1. If the amount of the pigment exceeds the upper limit, the strength of the ink receiving layer itself is lowered, and the resulting image hence tends to deteriorate in rub-off resistance and the like. On the other hand, if the binder to pigment ratio is too great, the ink-absorbing capacity of the resulting ink-receiving layer is reduced, and so the image formed may possibly be deteriorated.

Apart from the essential ingredients described above a cationic substance acting as mordant may be present in the ink receiving layer. Such substances increase the capacity of the layer for fixing and holding the dye of the ink droplets. A particularly suited compound is a poly(diallyldimethylammonium chloride) or, in short, a poly(DADMAC). These compounds are commercially available from several companies, e.g. Aldrich, Nalco, CIBA, Nitto Boseki Co., Clariant, BASF and EKA Chemicals.

Other useful cationic compounds include DADMAC copolymers such as copolymers with acrylamide, e.g NALCO 1470 trade mark of ONDEO Nalco or PAS-J-81, trademark of Nitto Boseki Co., such as copolymers of DADMAC with acrylates, such as Nalco 8190, trademark of ONDEO Nalco; copolymers of DADMAC with SO₂, such as PAS-A-1 or PAS-92, trademarks of Nitto Boseki Co., copolymer of DADMAC with maleic acid, e.g. PAS-410, trademark of Nitto Boseki Co., copolymer of DADMAC with diallyl(3-chloro-2-hydroxypropyl)amine hydrochloride, eg. PAS-880, trademark of Nitto Boseki Co., dimethylamine-epichlorohydrine copolymers, e.g. Nalco 7135, trademark of ONDEO Nalco or POLYFIX 700, trade name of Showa High Polymer Co.; other POLYFIX grades which could be used are POLYFIX 601, POLYFIX 301, POLYFIX 301A, POLYFIX 250WS, and POLYFIX 3000; NEOFIX E-117, trade name of Nicca Chemical Co., a polyoxyalkylene polyamine dicyanodiamine, and REDIFLOC 4150, trade name of EKA Chemicals, a polyamine; MADAME (methacrylatedimethylaminoethyl=dimethylaminoethyl methacrylate) or MADQUAT (methacryloxyethyltrimethylammonium chloride) modified polymers, e.g. ROHAGIT KL280, ROHAGIT 210, ROHAGIT SL144, PLEX 4739L, PLEX 3073 from Rohm, DIAFLOC KP155 and other DIAFLOC products from Diafloc Co., and BMB 1305 and other BMB products from EKA chemicals; cationic epichlorohydrin adducts such as POLYCUP 171 and POLYCUP 172, trade names from Hercules Co.; from Cytec industries: CYPRO products, e.g. CYPRO 514/515/516, SUPERFLOC 507/521/567; cationic acrylic polymers, such as ALCOSTAT 567, trademark of CIBA, cationic cellulose derivatives such as CELQUAT L-2OO, H-1OO, SC-240C, SC-230M, trade names of Starch & Chemical Co., and QUATRISOFT LM200, UCARE polymers JR125, JR400, LR400, JR30M, LR30M and UCARE polymer LK; fixing agents from Chukyo Europe: PALSET JK-512, PALSET JK512L, PALSET JK-182, PALSET JK-220, WSC-173, WSC-173L, PALSET JK-320, PALSET JK-320L and PALSET JK-350; polyethyleneimine and copolymers, e.g. LU PASOL, trade name of BASF AG; triethanolamine-titanium-chelate, e.g. TYZOR, trade name of Du Pont Co.; copolymers of vinylpyrrolidone such as VIVIPRINT 111, trade name of ISP, a methacrylamido propyl dimethylamine copolymer; with dimethylaminoethylmethacrylate such as COPOLYMER 845 and COPOLYMER 937, trade names of ISP; with vinylimidazole, e.g. LUVIQUAT CARE, LUVITEC 73W, LUVITEC VPI55 K18P, LUVITEC VP155 K72W, LUVIQUAT FC905, LUVIQUAT FC550, LUVIQUAT HM522, and SOKALAN HP56, all trade names of BASF AG; polyamidoamines, e.g. RETAMINOL and NADAVIN, trade marks of Bayer AG; phosphonium compounds such as disclosed in EP 609930 and other cationic polymers such as NEOFIX RD-S, trademark of Nicca Chemical Co.

The ink receiving layer, the adhesion promoting layer, and an optional auxiliary layer, such as a backing layer for anti-curl purposes, may further contain well-known conventional ingredients, such as surfactants serving as coating aids, hardening agents, plasticizers, whitening agents and matting agents. Surfactants may be incorporated in the layers of the recording element of the present invention. They can be any of the cationic, anionic, amphoteric, and non-ionic ones as described in JP-A 62-280068 (1987). Examples of the surfactants are N-alkylamino acid salts, alkylether carboxylic acid salts, acylated peptides, alkylsulfonic acid salts, alkylbenzene and alkylnaphthalene sulfonic acid salts, sulfosuccinic acid salts, α-olefin sulfonic acid salts, N-acylsulfonic acid salts, sulfonated oils, alkylsulfonic acid salts, alkylether sulfonic acid salts, alkylallylethersulfonic acid salts, alkylamidesulfonic acid salts, alkylphosphoric acid salts, alkyletherphosphoric acid salts, alkylallyletherphosphoric acid salts, alkyl and alkylallylpolyoxyethylene ethers, alkylallylformaldehyde condensed acid salts, alkylallylethersulfonic acid salts, alkylamidesulfonic acid salts, alkylphosphoric acid salts, alkyletherphosphoric acid salts, alkylallyletherphosphoric acid salts, alkyl and alkylallylpolyoxyethylene ethers, alkylallylformaldehyde condensed polyoxyethylene ethers, blocked polymers having polyoxypropylene, polyoxyethylene polyoxypropylalkylethers, polyoxyethyleneether of glycolesters, polyoxyethyleneether of sorbitanesters, polyoxyethyleneether of sorbitolesters, polyethyleneglycol aliphatic acid esters, glycerol esters, sorbitane esters, propyleneglycol esters, sugaresters, fluoro C₂-C₁₀ alkylcarboxylic acids, disodium N-perfluorooctanesulfonyl glutamate, sodium 3-(fluoro-C₆-C₁₁-alkyloxy)-1-C₃-C₄ alkyl sulfonates, sodium 3-(ω-fluoro-C₆-C₈-alkanoyl-N-ethylamino)-1-propane sulfonates, N-[3-(perfluorooctanesulfonamide)-propyl]-N,N-dimethyl-N-carboxymethylene ammonium betaine, fluoro-C₁₁-C₂₀ alkylcarboxylic acids, perfluoro-C₇-C₁₃-alkyl-carboxylic acids, perfluorooctane sulfonic acid diethanolamide, Li, K and Na perfluoro-C₄-C₁₂-alkyl sulfonates, N-propyl-N-(2-hydroxyethyl)perfluorooctane sulfonamide, perfluoro-C₆-C₁₀-alkylsulfonamide-propyl-sulfonyl-glycinates, bis-(N-perfluorooctylsulfonyl-N-ethanolaminoethyl)phosphonate, mono-perfluoro C₆-C₁₆ alkyl-ethyl phosphonates, and perfluoroalkylbetaine.

Useful cationic surfactants include N-alkyl dimethyl ammonium chloride, palmityl trimethyl ammonium chloride, dodecyldimethylamine, tetradecyldimethylamine, ethoxylated alkyl guanidine-amine complex, oleamine hydroxypropyl bistrimonium chloride, oleyl imidazoline, stearyl imidazoline, cocamine acetate, palmitamine, dihydroxyethylcocamine, cocotrimonium chloride, alkyl polyglycolether ammonium sulphate, ethoxylated oleamine, lauryl pyridinium chloride, N-oleyl-1,3-diaminopropane, stearamidopropyl dimethylamine lactate, coconut fatty amide, oleyl hydroxyethyl imidazoline, isostearyl ethylimidonium ethosulphate, lauramidopropyl PEG-dimoniumchloride phosphate, palmityl trimethylammonium chloride, and cetyltrimethylammonium bromide.

Especially useful are the fluorocarbon surfactants as described in e.g. U.S. Pat. No. 4,781,985, having a structure of: F(CF₂)₄₋₉CH₂CH₂SCH₂CH₂N⁺R₃X⁻ wherein R is a hydrogen or an alkyl group; and in U.S. Pat. No. 5,084,340, having a structure of: CF₃(CF₂)ₘCH₂CH₂O(CH₂CH₂O)ₙR wherein m=2 to 10; n=1 to 18; R is hydrogen or an alkyl group of 1 to 10 carbon atoms. These surfactants are commercially available from DuPont and 3M. The concentration of the surfactant component in the ink-receiving layer is typically in the range of 0.1 to 2%, preferably in the range of 0.4 to 1.5% and is most preferably 0.75% by weight based on the total dry weight of the layer.

The ink-receiving layer, the adhesion promoting layer, and the optional auxiliary layers may be crosslinked to provide such desired features as waterfastness and non-blocking characteristics. The crosslinking is also useful in providing abrasion resistance and resistance to the formation of fingerprints on the element as a result of handling. There are a vast number of known crosslinking agents—also known as hardening agents—that will function to crosslink film forming binders. Hardening agents can be used individually or in combination and in free or in blocked form. A great many hardeners, useful for the present invention, are known, including formaldehyde and free dialdehydes, such as succinaldehyde and glutaraldehyde, blocked dialdehydes, active esters, sulfonate esters, active halogen compounds, isocyanate or blocked isocyanates, polyfunctional isocyanates, melamine derivatives, s-triazines and diazines, epoxides, active olefins having two or more active bonds, carbodiimides, zirconium complexes, e.g. BACOTE 20, ZIRMEL 1000 or zirconium acetate, trademarks of MEL Chemicals, titanium complexes, such as TYZOR grades from DuPont, isoxazolium salts subsituted in the 3-position, esters of 2-alkoxy-N-carboxy-dihydroquinoline, N-carbamoylpyridinium salts, hardeners of mixed function, such as halogen-substituted aldehyde acids (e.g. mucochloric and mucobromic acids), onium substituted acroleins and vinyl sulfones and polymeric hardeners, such as dialdehyde starches and copoly(acroleinmethacrylic acid), and oxazoline functional polymers, e.g. EPOCROS WS-500, and EPOCROS K-1000 series, and maleic anhydride copolymers, e.g. GANTREZ AN119

In the practice of this invention boric acid is a preferred crosslinker.

The ink-receiving layer, the adhesion promoting layer and the optional auxiliary layers may also comprise a plasticizer such as ethylene glycol, diethylene glycol, propylene glycol, polyethylene glycol, glycerol monomethylether, glycerol monochlorohydrin, ethylene carbonate, propylene carbonate, tetrachlorophthalic anhydride, tetrabromophthalicanhydride, urea phosphate, triphenylphosphate, glycerolmonostearate, propylene glycol monostearate, tetramethylene sulfone, n-methyl-2-pyrrolidone, n-vinyl-2-pyrrolidone.

The different layers may also comprise ingredients to improve the lightfastness of the printed image, such as antioxidants, UV-absorbers, peroxide scavengers, singlet oxygen quenchers such as hindered amine light stabilizers, (HALS compounds) etc. Stilbene compounds are a preferred type of UV-absorber.

The different layers can be coated onto the RC-paper support by any conventional coating technique, such as dip coating, knife coating, extrusion coating, spin coating, slide hopper coating and curtain coating.

The present invention will now be illustrated by the following examples without however being limited thereto.

### EXAMPLES

### Example 1

### Ink-Receiving Layer (IRL)

A coating composition IRL-1 of the polymer blend type was prepared in an aqueous environment and contained:

100 parts of the commercial polyvinyl alcohol MOWIOL 8-88 from Clariant

5 parts of poly(dadmac), using the commercial poly(dadmac) CATFLOC L from Nalco Corp.

### Adhesion Promoting Layer (APL)

A first layer APL-1 was prepared in an aqueous environment and contained:

100 parts of the commercial boehmite DISPERAL HP14/2 from Sasol

25 parts of a polyvinyl alcohol binder from Nippon Gohsei

2.5 parts of boric acid

A second layer APL-2 was prepared in an aqueous environment and contained:

100 parts of aluminium oxide, using CAB-O-SPERSE PG003 from Cabot Corp.

6.5 parts of a polyvinyl alcohol binder from Nippon Gohsei

0.65 parts of boric acid

### Coatings

Support was a RC-paper base; coatings were performed with a cascade coater.

Coating number 1 (comparison) was a coating of the single layer of the ink receiving layer without intermediate adhesion promoting layer;

Coatings with number 2-7 were coatings in a two-layer wet on wet process according to table 1.

TABLE 1

| | | Adhesion | | | |
|---|---|---|---|---|---|
| | | promoting layer | | | |
| Coating | | | Dry | Ink-receiving layer | |
| Number | | Compos. | thickness | Compos. | Dry thickness |
| 1 | Compar. | No layer | | IRL-1 | 10 g/m² |
| 2 | Inv. | APL-1 | 2.5 g/m² | IRL-1 | 10 g/m² |
| 3 | Inv. | APL-1 | 5.0 g/m² | IRL-1 | 10 g/m² |
| 4 | Inv. | APL-1 | 7.5 g/m² | IRL-1 | 10 g/m² |
| 5 | Inv. | APL-2 | 2.6 g/m² | IRL-1 | 10 g/m² |
| 6 | Inv. | APL-2 | 5.2 g/m² | IRL-1 | 10 g/m² |
| 7 | Inv. | APL-2 | 7.8 g/m² | IRL-1 | 10 g/m² |

### Evaluation

Printing on Encad 600 ink jet Wide Format printer with GS+ dye-based inks (from Encad Co.).

Evaluation of smearing times: table 2 gives the times after printing that are needed to prevent the layer wetted with ink to de-adhere from the support and being rubbed together when smearing over the printed area with a gloved finger. The last column gives an overall evaluation figure in a scale from 5 (very bad) to 0 (excellent).

TABLE 2

| Coating | | | | | CMY | CMYK | CMY | Evalua- |
|---|---|---|---|---|---|---|---|---|
| number | C | M | Y | K | 70% | 70% | 100% | tion |
| 1 | 3 | 3 | 3 | 3 | 15 | 20 | 20 | 5 |
| 2 | 0 | 3 | 0 | 0 | 3 | 10 | 10 | 3 |
| 3 | 0 | 3 | 0 | 0 | 3 | 0 | 0 | 1 |
| 4 | 0 | 0 | 0 | 0 | 0 | 0 | 0 | 0 |
| 5 | 3 | 3 | 0 | 0 | 5 | 10 | 10 | 3 |
| 6 | 3 | 3 | 0 | 0 | 3 | 10 | 10 | 3 |
| 7 | 3 | 3 | 0 | 0 | 3 | 3 | 5 | 1-2 |

This results of table 2 of this example 1 clearly show the influence of the presence of the adhesion promoting layer on the adhesion of the ink-receiving layer during printing, resulting in much faster drying times.

Having described in detail preferred embodiments of the current invention, it will now be apparent to those skilled in the art that numerous modifications can be made therein without departing from the scope of the invention as defined in the appending claims.

1. An ink jet recording material comprising a resin coated paper support and an ink receiving layer, characterized in that between said support and said ink receiving layer there is an adhesion promoting layer present comprising a binder and a cationic inorganic pigment.

2. An ink jet recording material according to claim 1 wherein said cationic inorganic pigment is chosen from the group consisting of aluminum oxides, aluminum hydroxides, alumina hydrates, aluminum silicates, and cationically modified silicas.

3. An ink jet recording material according to claim 2 wherein said cationic inorganic pigment is boehmite.

4. An ink jet recording material according to claim 1 wherein the dry thickness of said adhesion promoting layer is comprised between 1 and 8 g/m².

5. An ink jet recording material according to claim 1 wherein the pigment/binder ratio in said adhesion promoting layer is comprised between 1:4 and 10:1.

6. An ink jet recording material according to claim 1 wherein said ink receiving layer substantially comprises only one or more polymers.

7. An ink jet recording material according to claim 6 wherein said one or more polymers are chosen from the group consisting of gelatin, polyvinyl alcohol and derivatives, polyvinyl pyrrolidone and derivatives, cellulosic ethers and derivatives, polyurethanes, and polyethylene oxides.

8. An ink jet recording material according to claim 1 wherein said ink receiving layer contains one or more pigments and one or more polymeric binders.

9. An ink jet recording material according to claim 8 wherein said pigment is chosen from the group consisting of aluminum oxides, aluminum hydroxides, alumina hydrates, aluminum silicates, and cationically modified silicas.

10. An ink jet recording material according to claim 1 wherein said ink receiving layer further comprises a cationic polymeric mordant.

11. An ink jet recording material according to claim 10 wherein said polymeric mordant is poly(diallyldimethylammonium chloride).

12. An ink jet recording material according to claim 1 wherein said resin coated paper support carries one or more subbing layers.
